(19) United States
(12) Patent Application Publication
(10) Pub. No.: US 2025/0021990 A1
(43) Pub. Date: Jan. 16, 2025

(54) SYSTEMS AND METHODS FOR VALIDATING TRAVEL DOCUMENTS IN HYBRID OPTICAL / BLUETOOTH LOW ENERGY MODE

(71) Applicant: AEP TICKETING SOLUTIONS S.R.L., Signa (IT)

(72) Inventors: Giovanni BECATTINI, Firenze (IT); Michele COLLU, Sesto Fiorentino (IT); Roberto DELL'EVA, Genova (IT)

(21) Appl. No.: 18/710,821

(22) PCT Filed: Nov. 22, 2022
(86) PCT No.: PCT/IB2022/061262

§ 371 Date: May 16, 2024

(30) Foreign Application Priority Data
Nov. 22, 2021 (IT) 102021000029477

(51) Int. Cl. G06Q 30/018; G06K 7/14; G06K 19/06; H04W 12/0471

(52) U.S. Cl. CPC G06Q 30/018; G06K 7/1417; G06K 19/06112; H04W 12/0471

(57) ABSTRACT

The system of the present invention employs a combination of optical reading of a QR code from the screen of a smartphone and a bidirectional data exchange by means of the Bluetooth Low Energy protocol with a validator device which exploits the MAC Address of the smartphone to establish a secure communication therewith.

### FIELD OF THE INVENTION

The present invention relates to a system for managing and validating public transport travel documents based on the use of hybrid optical/Bluetooth Low Energy (BLE) technology.

In particular, the present invention relates to a system for validating/verifying public transport travel documents based on the employment of two-dimensional bar code optical reading technology (QR codes) with the use of a smartphone of the traveling user provided with Bluetooth Low Energy connectivity.

The solution therefore provides for a secure exchange of validation media (tickets and/or virtual cards) by means of the Bluetooth Low Energy protocol.

### BACKGROUND ART

Various known solutions are currently available for validating travel documents. For example, it is possible to purchase in advance travel documents which are then made available on the mobile phone (see smartphone) of the user, who will then use and validate them, if necessary.

Various solutions are known in the art for obtaining the validation of a travel document previously purchased by the user.

A first mode provides for validation directly on the smartphone of the user, who selects one of the travel documents, previously purchased and readily available, and validates it, either manually by selecting the document and “punching” it virtually by means of an APP, or by bringing the mobile phone close to a validator which validates the selected travel document via NFC technology. Such modes have the disadvantage that, for example, they do not work with smartphones from Apple manufacturer, since such devices do not support NFC reading and writing functions. Alternatively, to validate a travel document on board the vehicle, it is possible to frame with the camera of the smartphone a static QR code printed on the validator or in the vicinity thereof (for example, on a vehicle or near a subway gate).

A further validation mode provides instead for the on-board validator to read the QR code relating to a travel document which is shown by the user on the screen of the smartphone, so that the on-board system may activate and validate the travel document by means of a connection with the control center: such validation works exclusively if the validator is capable of connecting to the control center, while it fails if the validator has no data connection.

As already mentioned, some of the more advanced ticketing systems provide for the use of travel documents based on mechanisms of the Account Based type (validation at the center) using, for example, the smartphone of the user to frame a static QR code suitably positioned on board the vehicle and, following such reading, a special APP on the smartphone of the user proceeds with requesting the validation of a travel document in Account Based mode (at the center) using the content of the static QR code read on the vehicle to locate the validation itself.

For example, the QR code read by the smartphone may contain vehicle data and a dedicated service at the center may cross-reference such information with the location data of the vehicle in question usually available centrally in fleet monitoring systems, which are called Automatic Vehicle Monitoring systems-AVMs.

The position data are then used by the validation services at the center to understand where the vehicle is at that moment and then proceed with the correct validation of the travel document in Account Based mode.

In these systems, the QR code, containing the contextual information and installed on board the vehicle or near an entrance gate (for example, at the entrance to a subway) is completely passive and static.

This passive and static feature does not allow to initiate actions following the validation itself such as, for example, the emission of an acoustic and/or visual signal on board the vehicle or the opening of a gate and/or a turnstile. It should be considered, for example, a subway gate; in this case, the validation action performed by the user at the center would not be recognized by the gate, which would therefore remain closed.

The same scenario is generally applicable to all cases where there is an unmanned access gate.

In addition to the issue indicated above, the static QR code positioned on board the vehicle may also be subjected to a fraudulent use, since it may be photographed by the user him or herself while boarding, or by an accomplice thereof, and then used to validate a travel document in a second moment, only as a result of an inspector boarding the vehicle. Therefore, if the inspector does not board the vehicle, the user does not proceed with the “real” validation of the travel document, but only takes a photograph of the static QR code and therefore the Account Based travel document is not used and remains valid for the next trip.

There are then systems which provide for the purchase of travel documents by means of smartphones and the validation thereof in optical mode (by means of QR codes), but which do not offer satisfactory features in terms of security and/or resistance to possible attacks. In fact, they provide for a one-way dialogue between the smartphone and the validation/verification apparatus by reading a QR code shown on the screen of the smartphone itself. This data exchange mode (one-way and read-only) allows for an attack which involves the simple graphic duplication (cloning) of the QR code shown on the screen, on the user device indicated as the “lawful smartphone”, by means of a screenshot or a photograph taken with another device and the subsequent forwarding thereof to an accomplice (whose device will be indicated as the “attacking smartphone”). In this scenario, the optical reader of the validator/verifier has no way of distinguishing whether it is reading the original data from the lawful smartphone or the one on the screen of the attacker (the QR code clone).

Furthermore, in general, the validator must be able to communicate constantly with the center to understand if the read QR code refers to a ticket yet to be validated or to a ticket which has already been validated in the past.

Furthermore, applications which provide for the validation of travel documents which are valid over a period, for example weekly or monthly travel documents, are substantially impracticable, since the validator would not distinguish the original QR code travel document from the copy and any attempt to limit travel by means of a connection to the center (e.g., ABT, where the term ABT means Account Based Ticketing) would fail, since it would in any case be impossible to distinguish the original QR code from the copy, i.e., they would both point to the same ABT pass which would therefore be valid for both.

Therefore, such optical validation mechanisms based on QR codes may be easily circumvented by means of screenshots and/or photographs of the screen and the subsequent forwarding “to third parties” by means of instant messaging.

Such QR Code is exposed to attacks of the cloning type. In the case of a visual verification by the inspector, the latter may perhaps realize that it is a copy (e.g., photo or screenshot) by virtue of various mechanisms such as, for example, displaying the current time on the same page.

However, a hardware apparatus (e.g., validator) is in no way capable of distinguishing the original from the copy. All the countermeasures adopted to prevent this, such as, for example, the generation of variable QR codes every few seconds/minutes, are easily circumvented by virtue of the new technology, for example: updating and displaying the updated QR code, taking a screenshot, forwarding to an accomplice by means of a quick messaging application, validation by the accomplice on the device thereof (directly from the messaging APP) and validation on a remote validator. Such operation may occur in a matter of seconds, nullifying any variable QR code protection mechanism.

Other countermeasures provide for the validation and “burning” of the travel document directly at the center (on a central server), but require a reliable and continuous connection between the validator and the central server; furthermore, such countermeasures may only be applied on deductible and/or single journey travel documents and may not at all be applied, for obvious reasons, to long-term travel documents (e.g., valid 100 minutes from validation, daily passes, monthly passes, annual passes, etc.) since, due to the issues described above, no ticketing system uses a QR code to validate a long-term travel document such as a pass (weekly, monthly, yearly, etc.), since it would be immediately used by thousands of users for the entire period of validity.

### SUMMARY OF THE INVENTION

To overcome the limitations due to the validation by means of QR codes, in which the QR code contains the “data” or “information” to be analyzed, the system proposed herein uses the QR code only to identify the smartphone which contains the “data” or “information” to be analyzed and not to contain the data itself.

It is therefore the task of the verification or control apparatus, i.e., of the validator or the entrance gate, to connect (exploiting Bluetooth Low Energy BLE technology) to collect the “data” or “information” to be validated/verified and then return it, again in Bluetooth Low Energy mode, to the lawful smartphone. Any copy of the QR code will do nothing but ask again to the exact same device for the travel document to be validated, whereby the classic “anti-passback” case occurs again.

It should be noted that, as it will be described soon, the validator may work in total autonomy and does not need to have any dedicated data connection with the central server for the purpose of validating QR code-based travel documents.

The invention described herein, while being applicable in an autonomous and independent context, may be used in conjunction with that contained in Italian Patent number 102018000010314, issued on Oct. 19, 2020 to the same Applicant, and allows to transfer in Bluetooth Low Energy mode virtual media which are called V-Tokens, thus allowing the secure validation of tickets of the QR code type as well as of virtual card passes (i.e., a V-Token containing a virtual card exchanged with the validator in Bluetooth Low Energy mode, as described in this document). Therefore, the joining of the two inventions also allows for the validation of virtual cards by means of QR codes as well as of QR code-based travel documents in general.

Such innovative feature is due to the fact of using the QR code not to contain the data to be exchanged but “its position”, and then using a protocol such as the Bluetooth Low Energy to exchange the data itself. The use of Bluetooth Low Energy as data exchange mechanism between smartphone and validation/verification apparatus allows the validated and/or verified object to be returned to the smartphone itself, thus allowing anti-passback mechanisms which may not be easily emulated with a simple QR code optically read, which, by nature, is a one-way (read-only) data communication channel.

The object of the invention has been achieved by a travel document validation system as defined in claim 1.

In particular, the travel document validation system based on the exchange of data in a secure mode comprises a traveling user device and a validator device. The traveling user device comprises an app for generating a QR code and is provided with a screen for displaying said QR code and with a Bluetooth Low Energy transmission and reception antenna. The validator device is provided with an optical reader capable of reading a QR code, and is provided with a Bluetooth Low Energy transmission and reception antenna.

The QR code generated by an app present on the traveling user device contains therein, in addition to other data, also the MAC Address of the traveling user device (MAC standing for Media Access Control).

The validator device extracts from the QR code, framed by the optical reader, the MAC Address of the traveling user device and uses it to connect in Bluetooth Low Energy mode, by means of the Bluetooth Low Energy transmission and reception antenna, to the traveling user device to perform the operation of validating the travel document.

Therefore, the validator device and the traveling user device establish a unique transmission in Bluetooth Low Energy mode therebetween.

In preferred embodiments, the validator device communicates with only one traveling user device at a time.

The validation system includes an “anti-passback” mechanism of the travel document which allows to block subsequent attempts to validate the same identical travel document just validated. This feature is due to the fact that the validated travel document is returned, by means of BLE, to the smartphone after the validation itself (and therefore modified with the validation date), therefore a second validation attempt, which is not allowed or too close in time, would immediately be identified. Preferably, in addition to the MAC address, the QR code also contains secure/unique access credentials to prevent an attack of the man in the middle/replay type, which is a type of security issue in which a third-party intercepts data transmissions with the purpose of using such data in some way, for example by resending the same data sequence or part of it. This issue is particularly felt in the BLE context, since the data transmission is freely interceptable by anyone within a radius of a few tens of meters.

Secure access credentials, introduced to counteract the attack described above, comprise a key for symmetric encryption. The invention contained herein will describe a possible implementation of the symmetric encryption algorithm. However, the concepts described herein are totally generic and independent of the encryption algorithm used, thus allowing the use of other current and future encryption algorithms.

In some embodiments, such as the one described herein, the key for symmetric encryption is of the Advanced Encryption Standard type and the same secret key is used for both encryption and decryption.

In particular, the implementation described herein provides that the symmetric key is never exchanged between the validator device and the traveling user device, but provides that only an identifying index of the key to be used is exchanged. Such index univocally identifies the key within a list present both in the validator device as well as in the traveling user device.

By means of the access credentials obtained by interpreting the QR code, the validator device establishes a secure encrypted communication channel with the traveling user device.

### BRIEF DESCRIPTION OF THE FIGURES

Further features and advantages of the invention will become apparent from the following description provided by way of a non-limiting example, with the aid of the Figures shown in the accompanying drawings, in which:

FIG. 1 shows a scenario, according to the present invention, of validation of travel documents based on the use of two-dimensional barcode optical reading technology with the use of a smartphone of the traveling user provided with Bluetooth Low Energy connectivity.

FIG. 2 shows a scenario, according to the present invention, of validation in a context in which a local attack is avoided by virtue of the anti-passback mechanism intrinsic in the system.

FIG. 3 shows a scenario, according to the present invention, in which an inspector verifies the travel document owned by a user using the same secure data exchange mode used during validation.

FIG. 4 shows a scenario, according to the present invention, in which a user uses the present invention to pass a gate regulated by a validator implementing this technology.

### DETAILED DESCRIPTION OF THE INVENTION

The proposed system therefore stands as an ideal complement to systems already existing and widespread, which provide for the purchase of travel tickets by means of smartphones and the validation thereof in optical mode (QR code), but which currently do not offer satisfactory features in terms of security, resistance to possible attacks and use in the context of partial/total absence of connectivity between the validator and the central server, such as, for example, an out-of-town car journey. Therefore, with some appropriate modifications, it is possible to make such systems resistant to fraudulent attacks and allow the use thereof even in contexts where the validator (or the inspector) does not have a present/stable data connection.

The solution described herein also uses a QR code but, in this case, the latter does not contain the travel document/data to be validated/verified, as it usually occurs in the prior art, but it contains the “position” thereof i.e. a reference to the physical device (smartphone of the traveler) containing it.

Furthermore, the validation occurs in a purely local (by means of BLE, thus enabling use also for Apple smartphones) and disconnected context, i.e., without involving central servers in the validation of the QR code itself, except in the case in which an Account Based validation is performed (ABT).

The “classic” Account Based mode, validated by means of QRC, works as follows:
At the center, stored in a database DB, there is the real travel document TK.
The smartphone of the traveling user has a reference to the travel document stored in the database, i.e., a serial number identified as the “Alias ID”.
Usually, in the case of validation by means of QRC codes, this unique serial number indicated with Alias ID is encoded within the QRC code (in any of the different ways available).
The validator reads the serial number Alias ID from the QRC code shown on the smartphone of the traveler and connects to the center and “validates online” ticket TK corresponding to the serial number “Alias ID”.
In the case where the QR code has been cloned, the validator does not know and may not distinguish the original QRC code from the copy thereof, and therefore the Alias ID optically read is “exposed”. The solution proposed herein provides that the smartphone of the user (lawful smartphone) has an available/active Bluetooth Low Energy connection and that the QR code contains the address of the smartphone itself, i.e., the Bluetooth MAC address thereof.

As soon as the validation and/or control apparatus reads the QR code, it extracts the “Bluetooth MAC address” data and uses it to univocally connect in Bluetooth Low Energy mode to the lawful smartphone, to then transfer, again in Bluetooth Low Energy mode, the travel document to be validated. This feature of uniqueness is fundamental in the case of Bluetooth Low Energy connections, since in these systems all parties communicate with each other (within the available range).

The proposed solution provides that the validator/verifier communicates with only one apparatus at a time, i.e., the smartphone of the traveling user which shows the QR code on the screen.

In the continuation of the description, reference will be made to a validation of a ticket or of virtual smartcards exchanged in Bluetooth Low Energy mode, but, in general, validations carried out in Account Based (ABT) mode are also possible.

In this second case, i.e., in the validation in ABT mode, it is not the virtual medium to be validated, i.e., the ticket, to be exchanged in Bluetooth Low Energy mode, but rather a reference thereto (i.e., an identifier of the travel document stored in the database DB of the central server). It should be noted that also in this case the reference to the ticket in ABT mode is not directly written in the QR code, therefore it may not be cloned/replicated exactly as in the case of a travel document locally on a smartphone.

In the case of validation in Account Based (ABT) mode, the following operations will occur.
Here too, at the center, stored in a database DB, there is the real travel document TK.
Also in this case, the smartphone of the traveling user has a reference to the travel document TK stored in the database DB, i.e., a unique serial number identified as the “Alias ID”.
In the solution proposed herein, unlike the case described above, the serial number Alias ID is not directly encoded in the QRC code, but it is exchanged by means of BLE between the smartphone and the validator.
The validator therefore accesses the serial number Alias ID by means of BLE, i.e., it reads it from the smartphone of the traveler, and then it connects to the center and “validates online” ticket TK by generating a validated ticket TKa.
Finally, the validator sends the validated document TKa in BLE mode to the smartphone of the traveler.

In this case, therefore, it is no longer necessary to copy the QRC code from the screen of the smartphone, because it does not contain the reference to the ticket, i.e., it does not contain the unique number Alias ID. In the past, optical validation mechanisms based on QR codes have been used; however, such systems are easily circumventable by means of screenshots and/or photographs of the screen and the subsequent forwarding “to third parties” by means of instant messaging apps, and require, in almost any case, a present and stable data connection between the validator and some central server which maintains the “validation status” of the travel document itself. This is due to the inherent one-way nature of the reading of a QR code.

The optical/Bluetooth Low Energy validation mode proposed herein is immune to these issues since, even if an attacker copies (or clones) the QR code from the smartphone of the lawful owner of the travel document and sends it to an accomplice (attacking smartphone), the Bluetooth Low Energy data exchange which would result from the attempted validation of the copy (clone) would fail, since the validator reading the “clone” QR code will never be capable of connecting in Bluetooth Low Energy mode to the smartphone which generated the original QR code, since the two MAC Addresses would not coincide, i.e., the smartphone of the lawful owner of the travel document would not be within the Bluetooth Low Energy range of the validator who is reading the clone QR code. Even if the smartphone of the lawful owner of the travel document was within the Bluetooth Low Energy range of the validator used by the attacker, the latter would still connect to the smartphone of the lawful owner of the travel document and not to the one of the attacker (local attack). To avoid a “fully local” attack, i.e., when the two smartphones are both within the Bluetooth Low Energy range of the two validators, for example on other validators of the same vehicle or on the validators contained in nearby gates in the case of a subway, an “anti-passback” mechanism of the travel document, provided in this invention and described below, would in any case prevent the second validation. The anti-passback mechanism, described in detail below, protects from the following scenario: two accomplices have the same copy of the QR code on the screen of the smartphones thereof (one QR code is the original one while the second one is the copy or clone). The two traveling users simultaneously try the validation on two different validators of the same vehicle, for example, the two accomplices boarded the same bus, one at the head and one at the rear of the vehicle. In both validations, the two validators would connect to the same device (smartphone containing the original QR code) since the MAC Address contained in the QR code shown to the validators is that of such device. The first validation will be successful, the second will fail due to the “anti-passback”, due to the attempted further validation of the same travel document, or the second validator will revalidate (after receiving it in Bluetooth Low Energy mode) the exact same “object” just validated by the first validator. The “anti-passback” mechanism itself also works in the case of side-by-side subway gates.

In the case where the second validator, the one used by the attacker, is outside the Bluetooth Low Energy range of the first device (lawful smartphone), then the validation fails due to a failed Bluetooth Low Energy connection.

The system of the present invention uses a combination of optical reading of a QR code from the screen of a smartphone and a bidirectional data exchange by means of the Bluetooth Low Energy protocol.

In particular, a possible scenario of use of the solution in the field of electronic ticketing will be described, i.e., the validation of travel documents based on virtual media hosted in the smartphone and exchanged between two apparatuses (validator and smartphone) using this invention.

However, it should be noted that the same invention may be adopted in all applications which provide for a secure reading of data between a control/verification apparatus (reader) and a smartphone application (data holder) such as, for example: access control and reading of sensitive data which may not be exposed to third parties by means of a “simple” QR code such as, for example, health data and/or personal data.

The Bluetooth Low Energy protocol has undoubted advantages, with respect to other solutions of the contactless emulation data exchange type (see NFC-HCE, i.e., Near-Field Communication-Host Card Emulation) since, unlike the NFC-HCE protocol, the Bluetooth Low Energy protocol may be used freely (without restrictions) even on smartphones of Apple manufacturer.

The data exchange mechanism is now described.

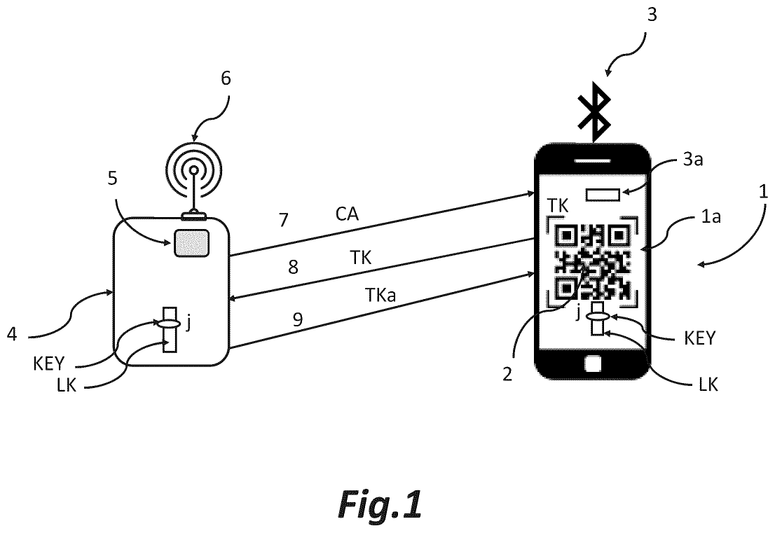

With reference to FIG. 1, a traveling user has a traveling user device, such as, for example, a smartphone, indicated with reference 1. Inside the smartphone 1 there is a travel document TK which must be verified/validated by a suitable validator device. Alternatively, in the case of ABT mode, inside smartphone 1 there is a reference Alias ID to the travel document TK stored in the database DB at the center. The validator device is indicated with reference 4 in FIG. 1. The traveling user displays a QR code (representing the request for validation of a travel document TK), indicated with reference 2, on the screen 1a of her/his smartphone 1.

Such QR code 2 is generated by an app available on the smartphone 1 and contains therein, in addition to other data, such as, for example, the date/time of the latest generation of the QR code 2 by the smartphone and the security items against forgery of the QR code itself (see digital signature of the QR code), also the MAC Address 3a which is a reference which allows to univocally identify the smartphone 1 which generated such QR code 2 and which owns the travel document TK (or the reference Alias ID to the travel document) stored in the database at the center in the memory thereof.

Therefore, the QR code 2, in addition to containing data for allowing a secure Bluetooth Low Energy exchange, it also contains the MAC Address 3a of the Bluetooth Low Energy transmitter present on the smartphone 1 which generated the QR code 2. For example, the Bluetooth Low Energy transmitter of the smartphone 1 is a Bluetooth Low Energy antenna indicated with reference 3. Therefore, the information relating to the MAC Address 3a of the smartphone 1 is included in the QR code 2 to have a unique identification of the smartphone 1.

After making the QR code 2 thus generated visible on the screen 1a of the smartphone 1, the traveling user puts the smartphone 1 close to the validator device 4 to validate/verify the travel document or ticket TK stored locally in the smartphone or in the database at the center.

The validator device 4, by means of an optical reader 5 capable of reading a QR code, frames and reads the QR code 2 generated by the app and displayed on the screen 1a of the smartphone 1, and extracts from it the MAC address 3a of the smartphone 1.

At this point, upon verifying the correctness of the digital signature of the QR 2, the validator device 4, by means of the Bluetooth Low Energy transmitter thereof, for example a Bluetooth Low Energy antenna indicated with reference 6, contacts the smartphone 1 using the MAC Address 3a read and extracted from the QR code 2 scanned by the optical reader 5. Finally, by means of the access credentials CA (i.e., type of protocol/encryption and index “j” of the symmetric key KEY to be used for encrypting the BLE communication) obtained by interpreting the QR code 2, the validator device 4 establishes a secure encrypted communication channel with the smartphone 1.

It should be noted that the two apparatuses (validator and smartphone) only exchange with one another the index of the key to be used (index “j”) and not the key itself (KEY). The “set of keys” (list of symmetric keys LK) must obviously be known to both before the validation process (system configuration step).

This operation of opening the communication between the validator 4 and the smartphone 1 is indicated in FIG. 1 with reference 7. In this step, the validator 4 sends to the smartphone 1 an authentication challenge obtained by digitally signing the QR code 2 read by means of the symmetric key KEY.

The smartphone 1, upon verifying the access credentials CA (verification of the correctness of the challenge), sends to the validator device 4 the ticket to be validated TK or the reference (Alias ID) to the travel document stored in the database at the center. This second operation of communication between the smartphone 1 and the validator 4 is indicated with reference 8.

Finally, validator device 4 hence receives ticket TK or the reference (Alias ID) to the travel document stored in the database at the center by means of Bluetooth Low Energy protocol, validator device 4 interprets it (i.e., validates it), and returns it validated TKa to the smartphone 1 in the operation indicated with reference 9. The smartphone 1 stores therein the validated ticket TKa, in a secure manner.

As mentioned, the validated ticket TKa exchanged between the validator 4 and the smartphone 1 is the virtual representation of the travel document TK to be validated or a reference thereof to the center Alias ID (see ABT). With reference to Italian Patent number 102018000010314, issued on Oct. 19, 2020 to the same Applicant, the data TK indicated herein may also be represented by a V-Token which would be stored, in a secure manner, in a special encrypted container (called Wallet) inside the smartphone itself. However, it should be noted that ticket TK is totally generic and may also be materialized with a content other than the V-Token. In practice, ticket TK represents the “private” and “sensitive” data to be exchanged in a secure and reliable manner between the two apparatuses (smartphone 1 and verification/validation apparatus 4).

With reference to FIG. 1, step 7 only occurs following the verification of the correctness of the QR code 2 by the validator 4. I.e., the digital signature and the date/time of the latest generation of the latter, i.e., of the QR code 2, which must not deviate too much from the current date/time so as to avoid unwanted reuse, is verified. In step 7, the validator 4 sends to the smartphone 1 a second digital signature suitably calculated by the validator 4 and verified by the smartphone 1 relating to the QR code 2 just read (or a hash thereof, then signed with a secret key). This second signature may be done, if desired, using the key KEY itself. This second signature is not mandatory for the purposes of the invention, but it may be used to prevent an attacking apparatus from having access to the data on the smartphone 1 of the user by emulating the validator 4 itself or by repeating, by means of BLE, an old data exchange or a part thereof.

Step 8 is the sending of ticket TK (V-Token to be validated) or of the reference thereof in Account Based mode from the smartphone 1 to the validator 4.

Step 9 is the sending of the validated ticket TKa (for example a validated V-Token) and the outcome of the validation itself (OK/KO) from the validator 4 to the smartphone 1 to notify the user.

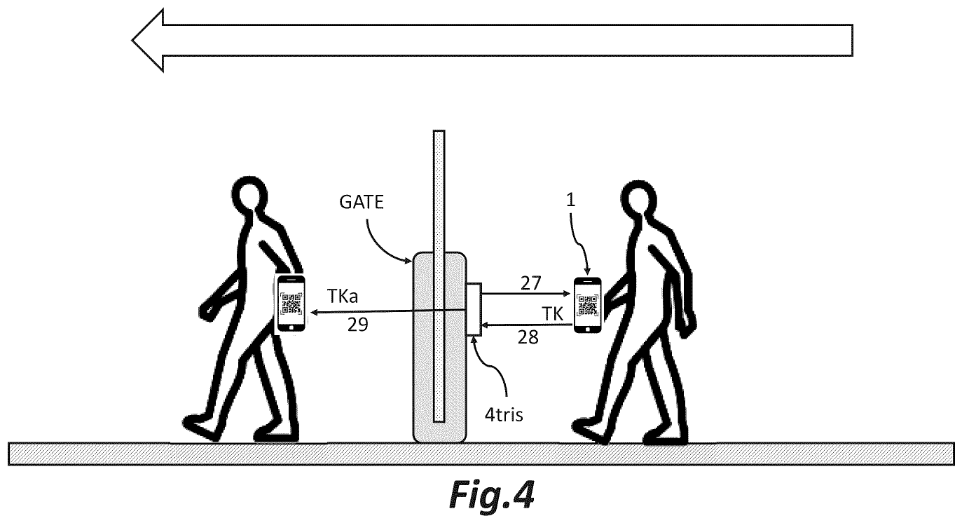

This sending of the subsequent validation result is particularly useful in the context of this invention, since the BLE data transmission, allowing medium-range communication, allows for the sending of the response to the user (validated travel document and validation result) even if the user is no longer in the vicinity of the validator 4 as it is necessary instead in the case of a validation based on the NFC protocol. This interesting feature, explained in the scenario of FIG. 4, may be exploited to speed up the passage of the users in the case where the validator 4 regulates access to a manned gate. In this case, the gate may be opened in advance with respect to the notification to the user. The notification, and the delivery of the validated document TKa, would only be made at a later time, i.e., when the user has already passed/freed the entrance regulated by the gate itself.

As mentioned above, the QR code 2 shown on the screen 1a of the smartphone 1, in addition to the MAC Address 3a of the smartphone 1 itself, also contains the secure access credentials CA. Such credentials CA, while not being a mandatory requirement for this invention, are used to avoid a man in the middle/replay attack. In this scenario, therefore, the QR code 2 contains therein, as secure access credentials CA, an index “j” of the key KEY to be used for symmetric encryption, and the information on the encryption algorithm to be used (for example, AES 128 bit, where AES stands for Advanced Encryption Standard, a data encryption algorithm based on a symmetric key in which the same secret key is used for both encryption and decryption, although, obviously, other encryption algorithms may be used).

In this solution scenario, the sender and the receiver of the data need a copy of the key. Such copy of the key is “negotiated” (by means of the index “j”) on an independent data channel (i.e., optical, see QR code) with respect to the data channel that the actual encryption (i.e., BLE) will use.

This “physical” separation between the key and the use thereof makes it even more difficult for an attacker to intercept and decode the “over-the-air” data exchange (i.e., the BLE transmission). It should be noted that only the index is exchanged and that such index is chosen at random each time, i.e., each time the QR code 2 is updated on the screen of the smartphone 1. The attacker may not “force” the choice of the index, since, as already explained, the QR code 2 is digitally signed, by the application on the smartphone 1, and verified, in advance, by the validator 4 before using the data contained therein.

It should be noted that the type of coding/encryption to be used for the data exchange in operations 8 and 9 is indicated by the validator 4 to the smartphone 1 in step 7; therefore, it will be possible, in the future, to use new symmetric key encryption algorithms and/or longer keys, thus preserving the backwards compatibility of the new smartphones 1, with updated software, with the old validators 4. In particular, the algorithm described herein (AES) is indicated only for explanatory purposes, as it is in fact possible to use any encryption algorithm.

Paradoxically, even “none” if one decides to solely rely on the data encryption/protection present within the BLE protocol itself.

In this example, the key KEY chosen for the symmetric encryption is then used in the data exchange between the validator 4 and the smartphone 1 and vice versa, i.e., in operations 7, 8 and 9. It should be noted that the symmetric key KEY is never exchanged between the two apparatuses, i.e., the smartphone 1 and the validator device 4, but only index j identifying the key KEY to be used is exchanged (such index j is randomly calculated among the number of possible keys). The two communicating devices, i.e., the smartphone 1 and the validator device 4, contain therein the set LK of possible keys to be used in this context. The set LK is inserted into the two software in a secure manner (i.e., encrypted, in turn) at the time of the release of the software itself.

The use of the symmetric key KEY (exchanged by indicating the index j of the key itself) is also used as mutual authentication, since it is used to prove that the two devices share the same security context, since the use of the same key KEY proves that the key set LK is homogeneous and of the correct version. In fact, it is assumed that such “set” varies over time.

The use of two different symmetrical keys (between the validator 4 and the smartphone 1) causes an immediate interruption of the data exchange, due to a decoding error, since the receiver would not be capable of correctly decoding the data sent by the transmitter itself.

The anti-passback protection mechanism is now described.

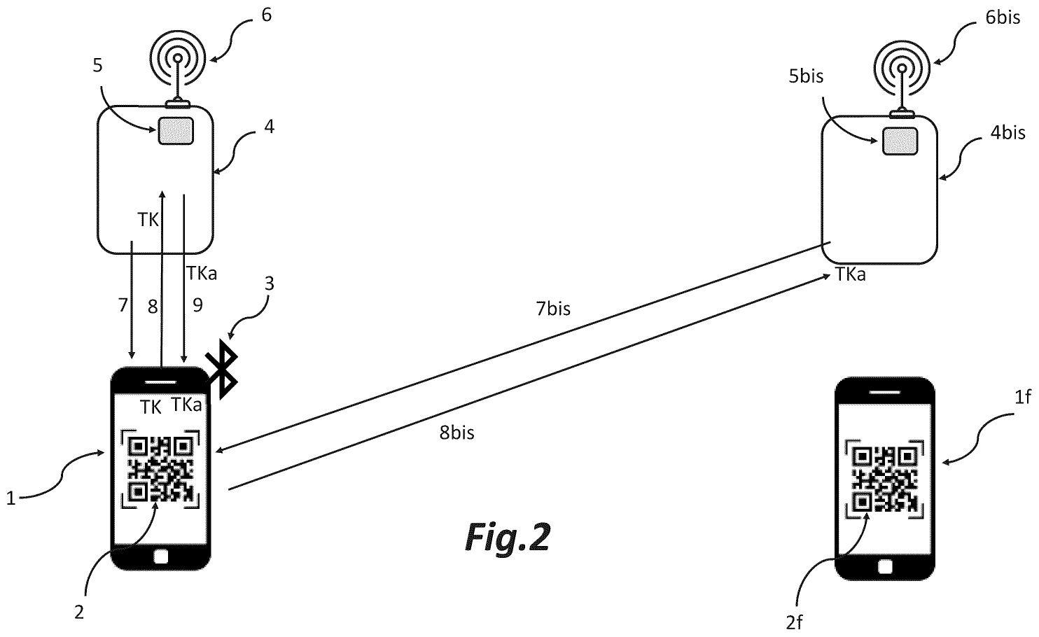

With reference to FIG. 2, a traveling user has a traveling user device, such as, for example, a smartphone, indicated with reference 1. Inside the smartphone 1 there is a travel document TK, or the reference (Alias ID) to the travel document stored in the database at the center, which must be verified/validated by a suitable validator device 4. The validator device is indicated with reference 4 in FIG. 2. As in the previous case (FIG. 1) the validator 4 reads the QR code 2 from the screen 1a of the smartphone 1 of the user, and connects (operation 7), by means of BLE, to the antenna 3 of the smartphone 1 using the MAC Address 3a read on the QR 2. As in the previous case, the validator 4 reads the travel document to be validated TK or the reference Alias ID thereof in the database at the center, in the operation indicated with reference 8 and returns it validated TKa in the operation indicated with reference 9. After the validation, the smartphone 1 has a new validated version of the travel document, TKa (i.e., validated TK).

At this point the attack begins, i.e., the owner of the smartphone 1 sends the QR 2 thereof (a copy of the generated image) to the user of the smartphone 1f, who displays it on the screen thereof obtaining the QR 2f. Such QR code 2f is then shown to the reader 5bis of a new validator 4bis to attempt the validation.

The validator 4bis carries out the preliminary checks (for example, digital signature check), such checks will obviously be passed since the QR 2f is a perfect copy of the QR 2. As before, the validator 4bis extracts from the QR 2f the MAC Address 3a to be contacted, but the address read will be that of the smartphone 1 and not that of the smartphone 1f, as the attacker would instead desire.

At this point, the validator 4bis, using the antenna 6bis thereof, connects to the smartphone 1 (with the connection indicated in FIG. 2 by arrow 7bis) and downloads the travel document to be validated (with the connection indicated in FIG. 2 by arrow 8bis). Since such travel document is TKa (and no longer TK), it is already validated (as indicated by arrow 9), therefore the second validation fails due to a repetition of a validation operation on the same identical travel document. In the world of ticketing, this protection against a second validation is called “anti-passback”, since it tends to counteract the passage of a ticket, which has just been validated, to an accomplice therebehind, to allow, in turn, the entry thereof.

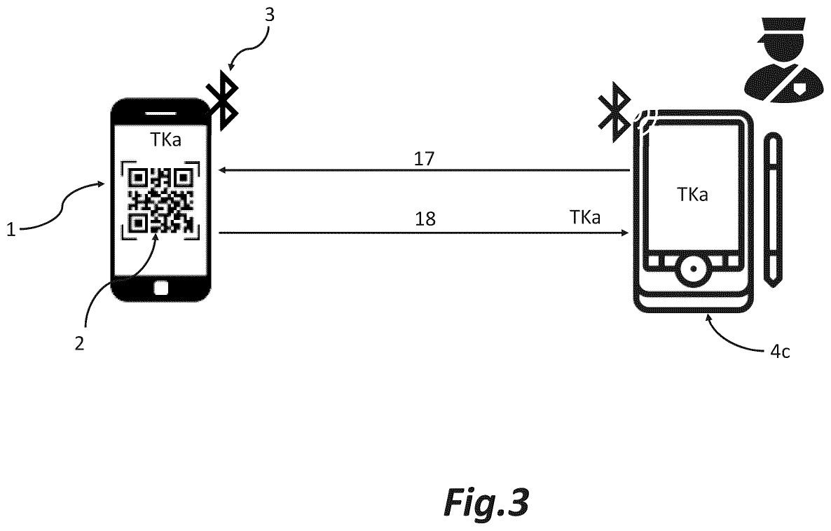

The mechanism for verifying the travel document by the inspector is now described. With reference to FIG. 3, an inspector, by means of the control palmtop 4c thereof, asks a user to show the validated travel document (TKa). The user then shows to the inspector her/his smartphone 1 on which the QR code 2 is present (the same one used for the validation). The control apparatus (palmtop 4c) reads the QR 2, it verifies the integrity thereof (digital signature) and establishes a BLE connection using the MAC Address 3a read on the QR 2 (exactly as during validation). Such connection is shown in the operation indicated with reference 17. The smartphone 1 responds to the request 17 by sending the validated travel document (TKa) again by means of BLE. Such operation is visible in the operation indicated with reference 18. At this point, the palmtop of the inspector 4c, having accessed the travel document Tka, may carry out the normal verification/control operations on such object. Obviously, if the ticket has not been validated and/or it is not compatible with the travel context, the inspector, by means of the palmtop 4c, will be able to notice this and may therefore be able to impose a fine on the user.

The travel document validation mechanism for passing a gate regulated by a validator implementing this technology is now described.

With reference to FIG. 4, a traveling user has a traveling user device, such as, for example, a smartphone, indicated with reference 1. The smartphone 1 contains therein a travel document TK, or the reference Alias ID to the travel document stored in the database at the center, and approaches a gate (indicated with GATE). The gate validator device is indicated with reference 4tris in FIG. 4. As in the previous cases, the validator 4tris reads the QR code from the screen of the smartphone 1 of the user, and connects (as shown in the operation indicated with reference 27) by means of BLE, to the antenna of the smartphone using the MAC Address 3a read on the QR 2. As in the previous case, the validator 4tris reads the travel document to be validated TK, or the reference Alias ID to the travel document stored in the database at the center, as shown in the operation indicated with reference 28 but, in this example, it returns it validated (TKa) in the operation indicated with reference 29 when the user has already passed the gate GATE. This particular feature allows the travel document validation event to be separated in time from the event of the delivery thereof, thus speeding up the passage of users in the case where transit is regulated by a barrier (gate GATE).

Obviously, without prejudice to the principle of the invention, the construction details and the embodiments may widely vary with respect to that described and illustrated above by way of example, without however departing from the scope of the present invention.

1. A system for validating travel documents (TK) based on the exchange of data in a secure mode comprises:
a traveling user device, and
a validator device,
wherein said traveling user device comprises an app for generating a QR code and is provided with a screen for displaying said QR code and with a Bluetooth Low Energy transmission and reception antenna,
wherein said validator device is provided with an optical reader capable of reading a QR code, and is provided with a Bluetooth Low Energy transmission and reception antenna,
wherein said QR code generated by said app present on the traveling user device contains therein, in addition to other data, also the MAC Address of said traveling user device,
and wherein said validator device extracts from said QR code, framed by the optical reader, the MAC Address of the traveling user device and uses it to connect in Bluetooth Low Energy mode, by means of the Bluetooth Low Energy transmission and reception antenna, to the traveling user device to perform the operation of validating the travel document, which generates a validated document which is returned to the traveling user device.

2. The validation system according to claim 1, wherein said operation of validating the travel document occurs in Account Based mode.

3. The validation system according to claim 2, wherein said traveling user device has stored therein a reference to the travel document stored in the database at the center.

4. The validation system according to claim 3, wherein said reference to the travel document is a unique serial number.

5. The validation system according to claim 1, wherein said QR code contains the position of the travel document to be validated or the MAC Address which is used to identify the traveling user device which contains the travel document.

6. The validation system according to claim 1, wherein said validator device extracts the MAC Address from said QR code and uses it to connect in Bluetooth Low Energy mode to the traveler user device to transfer the travel document to be validated by means of a bidirectional data exchange also in Bluetooth Low Energy mode.

7. The validation system according to claim 1, wherein said validator device and said traveling user device establish a unique transmission in Bluetooth Low Energy mode therebetween.

8. The validation system according to claim 1, wherein said validator device communicates with only one traveling user device at a time.

9. The validation system according to claim 1, wherein, in said system, an “anti-passback” mechanism of the travel document is adopted which allows to block subsequent attempts to validate the same identical travel document just validated.

10. The validation system according to claim 1, wherein the QR code, in addition to the MAC Address, also contains secure access credentials.

11. The validation system according to claim 9, wherein said secure access credentials comprise a key for symmetric encryption.

12. The validation system according to claim 10, wherein said secure access credentials comprise a key for encryption.

13. The validation system according to claim 11, wherein the same secret key is used for both encryption and decryption.

14. The validation system according to claim 12, wherein the same secret key is used in the data exchange between the validator device and the traveling user device and vice versa.

15. The validation system according to claim 13, wherein the symmetric key is never exchanged between the validator device and the traveling user device, but only an identifying index of the key to be used is exchanged.

16. The validation system according to claim 14, wherein the validating device and the traveling user device contain therein a set of possible keys to be used.

17. The validation system according to claim 1, wherein the validator device, by means of said access credentials obtained by interpreting the QR code, establishes a secure encrypted communication channel with the traveling user device.

18. The validation system according to claim 16, wherein the traveler user device, after verifying the access credentials, sends the travel document or the reference to the travel document stored in the database at the center, to the validator device.

19. The validation system according to claim 17, wherein the validator device receives the travel document or the reference to the travel document stored in the database at the center, by means of Bluetooth Low Energy protocol, validates it locally or in Account Based mode, and returns it validated to the traveling user device.

20. The validation system according to claim 18, wherein the traveling user device stores therein the validated travel document for a possible control by an inspector.
